(19) United States
(12) Patent Application Publication
(10) Pub. No.: US 2015/0253173 A1
(43) Pub. Date: Sep. 10, 2015

(54) FILL LEVEL MONITORING SYSTEM

(71) Applicants: Jacob Cedulf, Goteborg (SE); Björn Arendal, Goteborg (SE)

(72) Inventors: Jacob Cedulf, Goteborg (SE); Björn Arendal, Goteborg (SE)

(73) Assignee: SCA Hygiene Products AB, Göteborg (SE)

(21) Appl. No.: 14/417,693

(22) PCT Filed: Aug. 23, 2012
(86) PCT No.: PCT/SE2012/050894

§ 371 Date: Jan. 27, 2015

(51) Int. Cl. G01F 23/20

(52) U.S. Cl. CPC G01F 23/20

(57) ABSTRACT

A fill level monitoring system includes a dispenser (2) arranged to be fastened to a substantially vertical wall (3), and a load cell (4) for monitoring the fill level of a consumer product arranged to be stored within the dispenser (2). The dispenser (2) is arranged to be fastened to the vertical wall (3) by an upper fastening arrangement (7) and a lower fastening arrangement (8), the upper fastening arrangement (7) being provided with the load cell (4), and the load cell (4) being arranged to be sensitive mainly to horizontal forces in a fastened position of the dispenser (2).

### TECHNICAL FIELD

The present invention relates to a fill level monitoring system comprising a dispenser arranged to be fastened to a wall, and a load cell for monitoring the fill level of a consumer product arranged to be stored within said dispenser.

### BACKGROUND ART

The fill level of consumer products such as hand towels or liquid soap left in a dispenser is commonly monitored manually by responsible cleaning staff. This could be done by regularly opening the dispenser, or by inspecting the level through a transparent window. The cleaning staff subsequently refills the consumer products once an empty dispenser is identified. Manual monitoring is time-consuming and automatic monitoring systems have therefore been developed.

DE10047986A1 discloses an automatic detection system wherein several dispensers comprising sensors are connected to a display unit indicating the fill level. Optical sensors and weight sensors are used in the automatic detection system to determine the level of consumer products in the dispensers, and a signal is provided by the display unit when the level of consumer products is low. Thereby, it simplifies the monitoring of consumer product levels in the dispensers. DE10047986A1 discloses a general system but does not further disclose how the sensors may be arranged or configured in/on the dispenser units in order to offer accurate and reliable measurements or to avoid tampering.

U.S. Pat. No. 5,918,197 discloses a monitor for collecting data on consumer consumption of e.g. stacked paper towels during a limited testing period. The monitor comprises a working surface, a load cell and a recorder in a housing. The dispenser from which the consumption is being monitored is placed upon the working surface. A variation in weight due to consumption of the consumer products during the test period is recorded. The monitor is not integrated into the dispenser and is therefore mostly suitable for occasional fill level tests. Also, it is suitable for being arranged underneath the dispensers because the load cell is substantially sensitive to vertical forces exerted upon the working surface due to weight of the consumer products.

There is thus a need for an improved fill level monitoring system that provides an integrated, reliable and accurate monitoring system.

### SUMMARY

An object of the present disclosure is to provide an inventive product for monitoring the fill level of consumer product dispensers where the previously mentioned problems are partly avoided.

The disclosure relates to a fill level monitoring system comprising a dispenser arranged to be fastened to a substantially vertical wall, and a load cell for monitoring the fill level of a consumer product arranged to be stored within the dispenser.

The disclosure is characterised in that the dispenser is arranged to be fastened to the vertical wall by means of an upper fastening arrangement and a lower fastening arrangement, the upper fastening arrangement being provided with the load cell, and the load cell being arranged to be sensitive mainly to horizontal forces in a fastened position of said dispenser.

The disclosure is alternatively characterised in that the dispenser is arranged to be fastened to said wall by means of an upper fastening arrangement, said load cell being located below said upper fastening arrangement, said load cell being configured to be in contact with said vertical wall, and said load cell being arranged to be sensitive mainly to horizontal forces in a mounted position of said dispenser.

The provision of the load cell adjacent the rear wall of the dispenser results in minimized interference of the load cell installation itself with normal operation of the dispenser, such as dispensing operation and refill operation. Once properly mounted, the fill level monitoring system is likely to exhibit a high reliability and low service demand. The concealed location of the load cell installation further reduces the likelihood of tampering by consumers or the like, and does not negatively influence the aesthetic appearance of the dispenser. The innovative location of the load cell installation on the rear side of the dispenser, where the load cell is arranged to be sensitive mainly to horizontal forces further allows increased flexibility with respect to mounting of the dispenser, as no support surface is required beneath the dispenser, as would normally be required if the load cell was arranged beneath the dispenser and sensing a vertical force. The varying horizontal forces induced partly by the varying weight of the content of the dispenser is recorded by the load cell and converted into an electric signal, which may be received by an electronic control unit and interpreted by software.

Each of the two alternative load cell installations disclosed herein solve the problems of the prior art

The lower and upper fastening arrangements may be configured to enable displacement of a rear wall of the dispenser at the upper fastening arrangement in a direction perpendicular to the rear wall in response to varying weight of the consumer product. A dispenser filled with consumer products weighs more than an empty dispenser, and will hence induce a turning torque around the lower fastening arrangement. The turning torque will subsequently attempt to displace the rear wall of the dispenser at the upper fastening arrangement away from the vertical wall. The outward displacement of the rear wall compresses the load cell, which converts the physical compression to an electrical output signal.

The lower and upper fastening arrangements may be configured to enable the dispenser to substantially rotate around the lower fastening arrangement. The rotation around the lower fastening arrangement results in displacement of the rear wall of the dispenser at the upper fastening arrangement away from the vertical wall.

The rotation may be accomplished by means of a pivotal connection between the dispenser and the vertical wall at the lower fastening arrangement, or by means of local deformation of the rear wall at the region of the lower fastening arrangement. A pure pivotal connection, for example by means of a hinged mounting of the dispenser around a fixed axis of rotation, allows the dispenser to pivot forwardly without deformation of the dispenser as such, thereby allowing the dispenser to be made also of stronger and more rigid materials. A pivotal connection formed by means of local elastic deformation of the rear wall at the region of the lower fastening arrangement results in a more economical and compact solution that requires no additional components than the already for mounting purpose provided holes in the rear wall. The rear wall, and possibly also the side walls attached thereto, must however exhibit a certain degree of flexibility to allow deformation and bending of the rear wall in response to varying weight of the dispenser.

The lower fastening arrangement may comprise at least one hole in the rear wall of the dispenser, and a fastener that is arranged to penetrate the hole and press the rear wall of the dispenser against the vertical wall. The lower fastening arrangement thus prevents the rear wall of the dispenser from moving away from the vertical wall and operates as a rotational centre when the dispenser is trying to rotate due to consumer product weight. The dispenser is held in place by the fastener. The fastener may be a threaded member such as a screw, or any other suitable fastening means.

The upper fastening arrangement may comprise a load cell support member that is configured to be arranged within the dispenser and stationary fastened to the vertical wall through at least one hole in the rear wall, and the load cell may be configured to be installed between an inner surface of the rear wall and the load cell support member, such that a displacement of the rear wall in a direction perpendicular to the rear wall can be detected by the load cell. The rear wall presses against the load cell when being displaced in a direction perpendicular to the rear wall. As a result the load cell may measure the force needed to resist the displacement of the rear wall.

Further, the arrangement of the load cell support member within the dispenser and stationary fastened to the vertical wall allows for the load cell to be held securely in place. The load cell may be arranged concealed to the users of the dispenser, thereby preventing tampering and/or theft of the load cell.

The load cell support member may be made of a rigid material, the load cell support member may be configured to directly or indirectly abut the vertical wall, and at least one fastener may be arranged to press and fix the load cell support member directly or indirectly against the vertical wall. Due to the rigidity of the load cell support member the load cell will almost only be affected by horizontal forces arising from the displacement of the rear wall of the dispenser. Rear wall displacement occurs in response to varying weight of the consumer products and the load cell will therefore be sensitive to the weight of the consumer products.

The dispenser may comprise an actuation member. Further, the consumer product may be configured to be dispensed upon actuation of the actuation member, and an actuation surface of the actuation member being arranged substantially in the same vertical position as the lower fastening arrangement in a mounted position of the dispenser. Actuation of the actuation member in a horizontal direction would in this configuration not influence the load cell sensor output, because the actuation force vector would coincide with lower fastening arrangement, which defines the region of the pivoting axis.

The dispenser may be shaped such that a gap is formed between the rear wall and the vertical wall in an area below the lower fastening arrangement in a mounted position of the dispenser, such that a displacement of a rear wall of the dispenser at the upper fastening arrangement in a direction perpendicular to the rear wall is simplified. The gap facilitates the rear wall of the dispenser above the lower fastening means to tilt away from the vertical wall and simultaneously rotate around the lower fastening arrangement. Without the gap the rear wall could possibly abut against the vertical wall upon increased loading of the dispenser, and thereby reducing the displacement force measured by the load cell. Other solutions to simplify the displacement of the rear wall are also possible, such as using a flexible material in the rear wall below the lower fastening arrangement, or providing a spacer, such as a disc, between the rear wall and the vertical wall.

The upper fastening arrangement of the second embodiment of the invention may be configured to enable displacement of a rear wall of the dispenser below the upper fastening arrangement in a direction perpendicular to the rear wall in response to varying weight of the consumer product. The displacement of the rear wall of the dispenser exerts a horizontal force to the load cell located below the upper fastening arrangement. Thereby the load cell will record the horizontal forces in response to varying weight of the consumer product.

The upper fastening arrangement of the second embodiment may be configured to enable the dispenser to substantially rotate around the upper fastening arrangement. Thereby, the displacement of the rear wall is facilitated. The rotation of the dispenser causes the rear wall of the dispenser to exert horizontal forces on the load cell configured to be in contact with the vertical wall. The rotation depends on the force perpendicular to the direction of the rear wall, caused by the weight of the dispenser and the varying weight of the consumer products.

When the dispenser is arranged to rotate around the upper fastening arrangement, the rotation is accomplished by means of a pivotal connection between the dispenser and the vertical wall at the upper fastening arrangement, or by means of local deformation of the rear wall at the region of the upper fastening arrangement.

The upper fastening arrangement of the second embodiment may comprise at least one hole in the rear wall of the dispenser, and a fastener that is arranged to penetrate the hole and press the rear wall of the dispenser against the vertical wall. Thereby, the dispenser is enabled to rotate around the upper fastening arrangement without being displaced from the vertical wall at the position of the upper fastening arrangement. The dispenser is held in place by the fastener. The fastener may be a screw, or any other suitable fastening means.

The load cell in the second embodiment may be fastened to an outer surface of the rear wall. Thereby, the load cell is arranged in-between an outer surface of the rear wall and the vertical wall which it is configured to be in contact with. The vertical wall exerts a counteracting force on the load cell when the lower part of the rear wall of the dispenser is pressed against the vertical wall. The counteracting force is measured by the load cell.

In the second embodiment the dispenser is shaped such that a gap is arranged to be formed between the rear wall and the vertical wall in an area above the upper fastening arrangement in a mounted position of the dispenser, such that a displacement of a rear wall of the dispenser at the load cell in a direction perpendicular to the rear wall is simplified.

Both described embodiments of the fill level monitoring system may comprise a generally flat mounting bracket, or plate, that is configured to be fastened to the vertical wall, and the dispenser may be configured to be mounted on said mounting bracket. The flat mounting bracket facilitates correct mounting of the dispenser on the vertical wall, and prevents any misalignment of the load cell support member due to a non-flat vertical wall. A misaligned mounting of the load cell could reduce the effective measuring range of the load cell, and thereby reducing its measuring accuracy and resolution.

The consumer product may be liquid soap provided in a container, or a stack of hand towels, or a roll of absorbent sheet material, or any other consumer product. The weight of the total mass of the consumer products is reduced as the product is consumed i.e. removed from the dispenser.

The load cell may be calibrated corresponding to the weight of an empty dispenser as well as to the weight of a dispenser fully charged with consumer products.

The consumer product may be liquid soap provided in a container having opening nozzle. The dispenser may further comprise a supporting member for supporting the nozzle and transferring the weight from the container to the rear wall of the dispenser. The dispenser may be configured to provide a distinct and in the direction perpendicular to the rear wall narrow contact surface between the nozzle and the supporting member. This configuration of the dispenser assures that the contact surface between the container and supporting surface remains well-defined throughout the entire usage of the liquid soap. Thereby, the horizontal distance between the pivoting centre of the dispenser and the gravity force vector resulting from the mass of the refill container will be equally well-defined, such that the sensor output of the load cell can be correctly interpreted throughout the usage of the liquid soap.

The load cell may be secured to the load cell support member. At least the electronic circuits required to perform the fill level monitoring, and preferably also an electrical power source, may be provided within and/or on the load cell support member to provide a compact and reliable design that is cost-effective to manufacture.

The fill level monitoring system may comprise an electronic fill level indicator. The electronic fill level indicator may be arranged on the dispenser and/or on a separate control unit. Light emitting diodes, liquid crystal display, or similar may be used to indicate the current fill level for cleaning staff and users. Such indicators simplify the refilling procedure for cleaning staff, and indicate the consumer product level for users of the dispenser.

### BRIEF DESCRIPTION OF THE DRAWINGS

The present disclosure will now be described in detail with reference to the figures, wherein:

FIG. 1 shows a cross sectional side view of a first embodiment of a dispenser according to the invention;

FIG. 2 shows a front view of a first embodiment of the rear wall of the dispenser according to the invention;

FIG. 3 shows a cross sectional top view of a first embodiment of the upper fastening arrangement according to the invention;

FIG. 4 shows a cross sectional side view of a first embodiment of the upper fastening arrangement according to the invention;

FIG. 5 schematically shows the forces exerted on the dispenser according to the first embodiment of the invention;

FIG. 6 shows a cross sectional side view of a second embodiment of a dispenser according to the invention;

FIG. 7 shows a front view of a second embodiment of the rear wall of the dispenser according to the invention;

FIG. 8 schematically shows the forces exerted on the dispenser according to the second embodiment of the invention;

FIG. 9 schematically shows a dispenser with a roll according to the first embodiment of the invention;

FIG. 10 schematically shows a dispenser with a stack of towels according to the first embodiment of the invention;

FIG. 11 schematically shows dispenser installed on a mounting bracket.

### DETAILED DESCRIPTION

Various aspects of the disclosure will hereinafter be described in conjunction with the appended drawings to illustrate and not to limit the invention, wherein like designations denote like elements, and variations of the inventive aspects are not restricted to the specifically shown embodiments, but are applicable on other variations and embodiments of the invention.

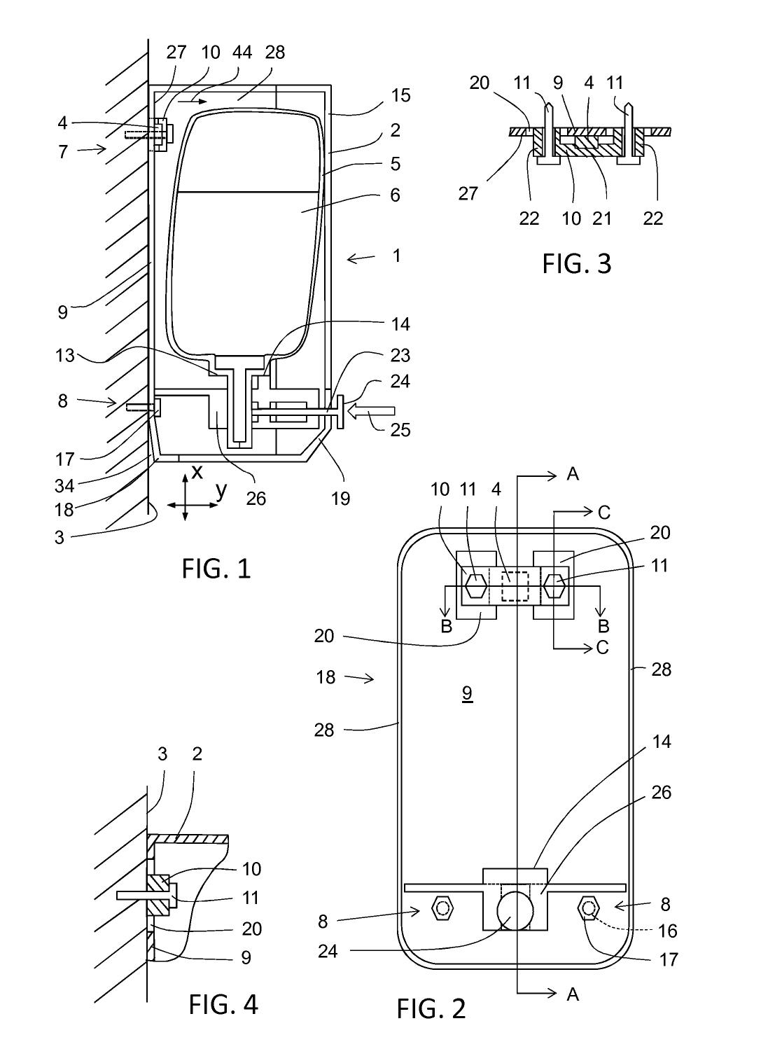

FIG. 1 shows a fill level monitoring system 1 comprising a dispenser 2 in a mounted position according to a first embodiment of the invention. The dispenser 2 is fastened to a vertical wall 3 and is provided with a refill container 5 containing liquid soap 6. The dispenser 2 comprises a rear part 18 having a rear wall 9 and two oppositely located side walls 28, a front part 19 having a front wall 15. The dispenser is fastened to the vertical wall 3 by an upper fastening arrangement 7 and a lower fastening arrangement 8, further described in FIG. 3 and FIG. 4. A load cell 4 for monitoring the fill level of the liquid soap 6 is provided at the upper fastening arrangement 7 in a load cell support member 10. The load cell 4 is sensitive to horizontal forces subjected to it by the load cell supporting member 10 and the rear wall 9. The horizontal direction corresponds to direction y in FIG. 1, and the vertical direction corresponds to the direction x. In FIG. 1 the rear wall 9 of the dispenser 2 is arranged against the vertical wall 3, however the lower fastening arrangement 8 and the upper fastening arrangements 7 are configured to enable at least a small displacement of the rear wall 9 of the dispenser 2 in a region of the upper fastening arrangement 7 in a direction perpendicular to the rear wall 9, i.e. in the horizontal direction. Said displacement is according to the disclosed embodiment enabled by fixedly securing the rear wall 9 to the vertical wall 3 at the area of the lower fastening arrangement 8, and in addition allowing the rear wall 9 in an area above the lower fastening arrangement 8 to bend outwardly in response to increased fill level of the refill container 5. The lower fastening arrangement 8 can consequently be considered enabling rotation of the dispenser 2 around its lower fastening arrangement 8 by means of a type of pivotal connection.

The lower fastening arrangement 8 comprises a hole 16 in the rear wall 9 of the dispenser 2 and a fastening member 17 which penetrates the hole 16 and presses the rear wall 9 against the vertical wall 3. The rear wall 9 of the dispenser 2 is preferably angled away to form a gap 34 between the vertical wall 3 and rear wall 9 in a region below the lower fastening arrangement 8 for the purpose of simplifying outward displacement 44 of the rear wall 9 at the upper fastening arrangement 7 when the dispenser rotates or bends clockwise with a pivot centre in the region of the lower fastening arrangement 8.

FIG. 2 shows the rear part 18 of the dispenser 2 from a front view having the front part 19 and refill container 5 removed. FIG. 1 corresponds at least partly to cross-sectional A-A of FIG. 2. The lower fastening arrangement 8 comprises two spaced apart holes 16 in the rear wall 9, each receiving a fastening member 17, such as a screw, that is configured to be engaged in the vertical wall 3. The bending rigidity of the dispenser 2, in particular the rear wall 9 in the region of the lower fastening arrangement 8, must be kept relatively low to enable to upper part of the dispenser 2 to displace outwardly, as depicted by arrow 44 in FIG. 1, in response to increased loading of the dispenser, for example upon installation of a full refill container 5.

The two holes 20 in the rear wall 9 of the upper fastening arrangement 7 are clearly visible in FIG. 2. The load cell support member 10 penetrates said holes 20 and enables the load cell support member 10 to be firmly clamped directly against the vertical wall 3. The load cell support member 10 is shaped as a bracket having a central elongated region 21 for receiving and holding the load cell 4, and two projecting abutment portions 22 arranged at opposite ends of the central region 21.

The abutment portions having a length sufficient to at least extend through the holes 20 of the rear wall 9. The load cell support member 10 is preferably rigid to prevent deflection thereof upon varying loading level of the dispenser, which defection may lead to distortion of the load cell output. The load cell support member 10 may be made of a durable and rigid plastic material, such as polyurethane or the like, and holds the load cell 4 in correct position in-between two abutment portions 22 by any suitable means.

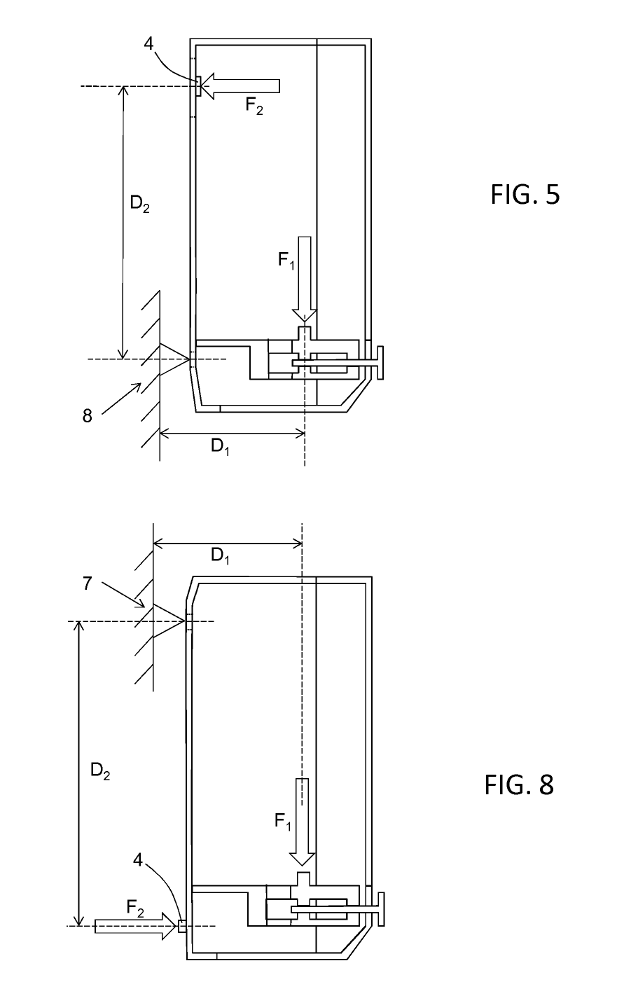

The length of the abutment portions 22 are preferably selected such that the load cell 4 exhibits a small precompression in an empty state of the dispenser, i.e. without the refill container 5 installed therein, or at least with an empty refill container 5. The thickness of the rear wall 9 and position of the load cell in the load cell support member 10 must of course also be taken into consideration for attaining the required precompression. A precompression of the load cell in an empty state allows the load cell to accurately detect and measure the increased compressive force that the load cell 4 exhibits due to increased loading of the dispenser, as will be explained more in detailed in with respect to FIG. 5. Without the precompression, small levels of loading will be more difficult to detect with the load cell.

The dispenser 2 may comprise a manual dispensing mechanism, as illustrated schematically in FIGS. 1 and 2. The manual dispensing mechanism may comprise an actuation member 23, and a consumer product of the refill container 5, such as liquid soap, is configured to be dispensed upon actuation of the actuation member 23. An actuation surface 24 of said actuation member 23 is preferably arranged substantially in the same horizontal plane as the lower fastening arrangement 8 for the purpose of minimizing influence of the manual actuation itself onto the load cell output signal. By locating the actuation member 23 substantially in the same horizontal plane as the lower fastening arrangement 8, the pivoting motion of the dispenser due to the manual actuation force vector 25 is minimized. The dispenser further comprising a supporting member 26 for supporting the refill container 5 within the dispenser 2, and in particular for supporting the nozzle 13 of such a refill container 5.

FIGS. 3 and 4 show the upper fastening arrangement comprising a load cell 4 and a load cell support member 10 according to cross-section B-B and C-C respectively of FIG. 2. The load cell support member 10 is arranged within the dispenser 2, and is stationary fastened to the vertical wall 3 through two holes in the load cell support member 10 and two corresponding holes in the rear wall 9. Two parallel screws 11 fasten the load cell support member 10 to the vertical wall 3. The screws 11 pass through the two holes 20 in the rear wall 9 before entering the vertical wall 3. The load cell 4 is installed between the inner surface 27 of the rear wall 9 and the load cell support member 10. The degree of displacement of the rear wall 9 in a direction perpendicular to the rear wall 9, i.e. if the upper portion of the dispenser displaces away from the vertical wall 3, may consequently be detected by the load cell 4.

The load cell support member 10 directly abuts to the vertical wall 3 through two screws as seen in FIG. 3. One or more spacer elements may of course be provided between the abutment portions 22 and the vertical wall 3 for load cell calibration purposes, or the like. Upon increased loading of the dispenser, the rear wall 9 will become increasingly spaced from the vertical wall 3, such as a gap between the vertical wall 3 and the rear wall 9 is formed, which gap essentially corresponds to the compression level of the load cell, possibly also including any deflection of the load cell support member.

In detail, if the dispenser 2 is provided with a refill container 5 full with liquid soap 6, the rear wall 9 of the dispenser 2 will tilt away from the vertical wall 3 at the upper fastening arrangement 7 due to the weight of the liquid soap 6. FIG. 5 schematically shows the forces (indicated by arrows) exerted on the dispenser 2 of the first embodiment due to the refill container 5. The consumer product container is not shown in FIG. 5. An empty dispenser 2 in a vertically aligned position according to the first embodiment is shown in FIG. 5, and lower fastening arrangement is here considered as a pure pivotal fastening arrangement. Due to the specific configuration of the upper and lower fastening arrangement in combination with the deformable rear wall 9 of the dispenser, the dispenser 2 will exhibit a certain degree of rotation, or bending, in the region of the lower fastening arrangement 8 when a vertical gravitational force F1 is exerted on the supporting member 26 a distance D1 from the lower fastening arrangement 8. The gravitational force F1 corresponds to the mass of the refill container and its content multiplied with the gravitational acceleration. The gravitational force F1 spaced a distance D1 from the lower fastening arrangement induces a rotational torque that urges the dispenser to tilt forward. This forward tiling motion is however substantially prevented by means of the counter force F2 exerted by the load cell 4, which is firmly secured to the vertical wall 3 behind the dispenser 2. The counter force F2 depends on the induced rotational torque and the distance D2, such that F1×D1=F2×D2. From this equation, it is clear that the sensor output of the load cell is directly dependent on the weight of the consumer products, i.e. depending on the fill level of the refill container 5. As a result, the fill level may be continuously measured by the load cell. The weight of the dispenser itself if here ignored since it is constant.

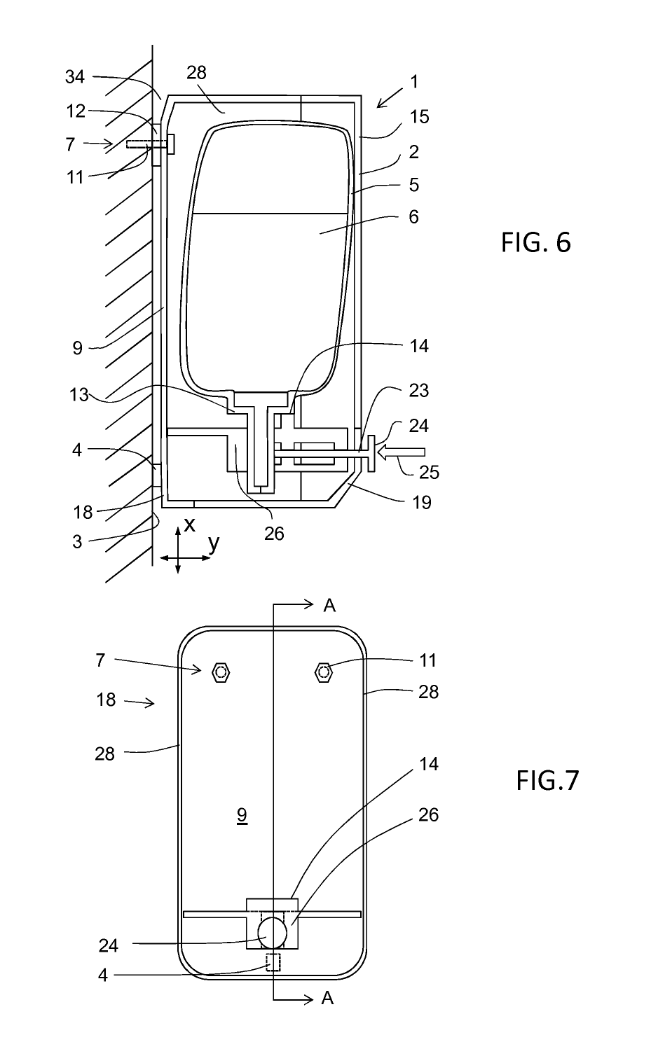

The second embodiment of the fill level monitoring system 1 according to the invention is shown in FIGS. 6, 7 and 8, and comprising a dispenser 2 fastened to a vertical wall 3, wherein the dispenser 2 is provided with a refill container 5 containing liquid soap 6. The dispenser 2 is fastened to the vertical wall 3 by an upper fastening arrangement 7. The upper fastening arrangement 7 is configured to enable displacement of the rear wall 9 of the dispenser 2 below the upper fastening arrangement 7 in a direction perpendicular the rear wall 9. Thereby, the dispenser 2 may essentially rotate or bend around the upper fastening arrangement 7 in response to varying loading degree of the refill container 5.

A load cell 4 is located below the upper fastening arrangement 7, and preferably fastened to an outer surface of the rear wall 9 and in contact with the vertical wall 3. The load cell 4 is sensitive to horizontal forces subjected to it by the vertical wall 3 and the rear wall 9.

The rear wall 9 is shaped such that there is a gap 34 between the vertical wall 3 and the rear wall 9 above the upper fastening arrangement 7. Further, a spacer 12 may preferably be arranged between the outer surface of the rear wall 9 and the vertical wall 3. The gap 34 and/or the spacer 12 simplify the displacement of the rear wall 9 at the region of the load cell 4 in a direction perpendicular to the rear wall 9. The rear wall 9 may thereby essentially rotate or bend around the upper fastening arrangement 7. The rear wall 9 comprises two holes, as shown in FIGS. 6 and 7, and two screws 11 penetrate the two holes and press the rear wall 9 against the vertical wall 3. The dispenser 2 according to the second embodiment of the invention consequently hangs at the upper fastening arrangement 7, and the lower part of the dispenser is free to horizontally displace a certain limited distance in response to more or less loading degree of the dispenser.

The mounting of the refill container 5 within the dispenser 2, the support member 26, and actuation member 23 is identical to the first embodiment. One difference being that the actuation force vector 25 exerted upon the actuation surface 24 by the user cannot be prevented from temporarily influencing the load cell output. This aspect may however be used for counting the number of actuations, such as to facilitate additional information for improved fill level monitoring, or other statistic evaluation. This additional information may of course be provided to the first embodiment as well by merely vertically displacing the location of the actuation member 23 and lower fastening arrangement 8.

The load cell 4 is here arranged centrally at the lower region of the dispenser, and two fastening screws 11 are provided, but many other configurations of the load cell is possible within the scope of the invention.

FIG. 8 schematically shows the forces (indicated by arrows) exerted on the dispenser 2 due to the refill container 5. The consumer product container is not shown in FIG. 8, and the upper fastening arrangement 7 is here considered as a pure pivotal fastening arrangement. FIG. 8 shows the second embodiment of the inventive dispenser 2 in a vertically aligned position. When the dispenser 2 is filled with consumer products the weight of the consumer products will exert a vertical force F1 on the dispenser 2. The vertical force F1 will induce a rotational torque around the upper fastening arrangement 7 and a horizontal counter force F2 will be exerted on the load cell 4 by the vertical wall 3. The load cell 4 will consequently measure the compressive force exerted thereto. The measured horizontal counter force F2 is proportional to the mass of the consumer products. The counter force F2 dependents on the induced rotational torque and the distance D2, such that F1×D1=F2×D2. The fill level of consumer products, based on mass, can thus be determined by the load cell.

In both disclosed embodiments the refill container 5 comprising the liquid soap 6 is configured to rest on a well-defined narrow contact surface 14. As shown in FIG. 1 and FIG. 6 the container 5 is resting on a narrow contact surface 14 located between an opening nozzle 13 of the refill container and a supporting member 26 of the dispenser 2. Thereby, the distance D1 is more accurately known, thereby allowing a more accurate estimation of the current fill level. Without a well-defined contact surface between the refill container 5 and the supporting member 26, the resulting rotational torque is not accurately known, thereby preventing an accurate estimation of the gravitational force of the dispenser 2 and refill container 5. As an alternative to a narrow contact surface 14 on a projection of the supporting member 26 the refill container may be arranged in a tilted spatial position, for example forward tilted position, such that only a small part of the opening nozzle 13 is contacting the supporting member 26, thereby also generating a well-defined contact surface between the refill container and the supporting member 26.

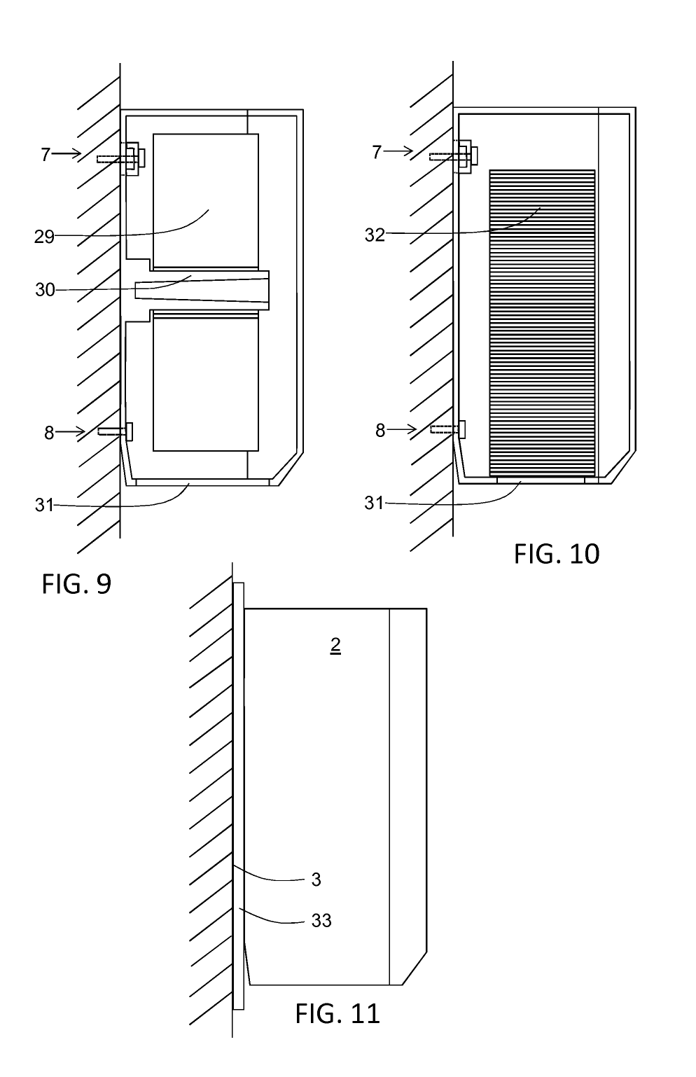

The fill level monitoring system is not limited to liquid soap dispenser, but is equally applicable to other types of consumer products. FIG. 9 for example illustrates a dispenser according to the first embodiment carrying a wound paper roll 29, which is rotatably arranged on and penetrated by a stationary shaft 30 of the dispenser 2, such has an opening 31 at a lower end thereof for dispensing of a leading tail of the roll 29. Still a further example of another consumer product is illustrated in fig.10, where a dispenser according to the first embodiment carrying a stack of towels 32, such as paper towels, is showed.

FIG. 11 shows a dispenser according to the first or second embodiment having a flat mounting bracket 33 installed between the vertical wall 3 and the dispenser 2. The flat mounting bracket 33 facilitates simplified and correct mounting of the dispenser on the vertical wall, and prevents any misalignment of the load cell support member due to a non-flat vertical wall. The mounting bracket 33 is mounted to the vertical wall 3, and the dispenser 2 is mounted to the mounting bracket 33.

The term “load cell” herein refers to a transducer that is used to convert a force into electrical signal. A load cell may measure force or torque using a strain gauge as a sensing element. The strain gauge, which may comprise a wire, is deformed by the force to be measured, and the strain gauge measures the deformation (strain) as an electrical signal, because the strain changes the effective electrical resistance of the wire. The load cell might be a beam load cell, a donut shaped load cell, a micro load cell, a button load cell or any other suitable load cell. The output of the load cell is plugged into an algorithm to calculate the current fill level of the refill container 5.

The term “dispenser” is considered to encompass all different kinds of dispensers for consumer products.

The degree of rotation and/or bending of the dispenser 2 upon varying loading levels of the refill container 5 is relatively small, and is mainly determined by the mechanical deflection of the measuring elements of the load cell. This mechanical deflection, which consequently corresponds to the displacement of the rear wall 9 at the load cell 4, is typically in the range of 0.1 mm −5 mm, depending on the type of load cell used.

As will be realised, the invention is capable of modification in various obvious respects, all without departing from the scope of the appended claims. Accordingly, the drawings and the description thereto are to be regarded as illustrative in nature, and not restrictive.

1. A fill level monitoring system comprises a dispenser arranged to be fastened to a substantially vertical wall, and a load cell for monitoring a fill level of a consumer product arranged to be stored within said dispenser, wherein said dispenser is arranged to be fastened to said vertical wall by an upper fastening arrangement and a lower fastening arrangement, said upper fastening arrangement being provided with said load cell, and said load cell being arranged to be sensitive mainly to horizontal forces in a fastened position of said dispenser.

2. The fill level monitoring system according to claim 1, wherein said lower and upper fastening arrangements are configured to enable displacement of a rear wall of said dispenser at said upper fastening arrangement in a direction perpendicular to said rear wall in response to varying weight of said consumer product.

3. The fill level monitoring system according to claim 2, wherein said lower and upper fastening arrangements are configured to enable said dispenser to substantially rotate around said lower fastening arrangement.

4. The fill level monitoring system according to claim 3, wherein said rotation is accomplished by a pivotal connection between said dispenser and said vertical wall at said lower fastening arrangement, or by local deformation of said rear wall at the region of the lower fastening arrangement.

5. The fill level monitoring system according to claim 2, wherein the lower fastening arrangement comprises at least one hole in said rear wall of said dispenser, and a fastener that is arranged to penetrate said hole and press said rear wall of said dispenser against the said vertical wall.

6. The fill level monitoring system according to claim 2, wherein said upper fastening arrangement comprises a load cell support member that is configured to be arranged within said dispenser and stationary fastened to said vertical wall through at least one hole in said rear wall, and said load cell is configured to be installed between an inner surface of said rear wall and said load cell support member, such that a displacement of said rear wall in a direction perpendicular to said vertical wall can be detected by said load cell.

7. The fill level monitoring system according to claim 6, wherein said load cell support member is made of a rigid material, said load cell support member is configured to directly or indirectly abut said vertical wall, and at least one fastener is arranged to press said load cell support member directly or indirectly against said vertical wall.

8. The fill level monitoring system according to claim 1, wherein said dispenser comprises an actuation member, said consumer product is configured to be dispensed upon actuation of said actuation member, and an actuation surface of said actuation member being arranged substantially in the same vertical position as said lower fastening arrangement in a mounted position of said dispenser.

9. The fill level monitoring system according to claim 2, wherein the dispenser is shaped such that a gap is arranged to be formed between said rear wall and said vertical wall in an area below said lower fastening arrangement in a mounted position of said dispenser, such that a displacement of the rear wall of said dispenser at said upper fastening arrangement in a direction perpendicular to said rear wall is simplified.

10. A fill level monitoring system comprises a dispenser arranged to be fastened to a substantially vertical wall, and a load cell for monitoring the fill level of a consumer product arranged to be stored within said dispenser wherein said dispenser is arranged to be fastened to said vertical wall by an upper fastening arrangement, said load cell being located below said upper fastening arrangement, said load cell being configured to be in contact with said vertical wall, and said load cell being arranged to be sensitive mainly to horizontal forces in a mounted position of said dispenser.

11. The fill level monitoring system according to claim 10, wherein said upper fastening arrangement is configured to enable displacement of a rear wall of said dispenser below said upper fastening arrangement in a direction perpendicular to said rear wall in response to varying weight of said consumer product.

12. The fill level monitoring system according to claim 11, wherein said upper fastening arrangement is configured to enable said dispenser to substantially rotate around said upper fastening arrangement.

13. The fill level monitoring system according to claim 12, wherein said rotation is accomplished by means of a pivotal connection between said dispenser and said vertical wall at said upper fastening arrangement, or by means of local deformation of said rear wall at the region of said upper fastening arrangement.

14. The fill level monitoring system according to any of claim 11, wherein said upper fastening arrangement comprises at least one hole in said rear wall of said dispenser, and a fastener that is arranged to penetrate said hole and press said rear wall of said dispenser against said vertical wall.

15. The fill level monitoring system according to claim 11, wherein said load cell is fastened to an outer surface of said rear wall.

16. The fill level monitoring system according to claim 11, wherein dispenser is shaped such that a gap is arranged to be formed between said rear wall and said vertical wall in an area above said upper fastening arrangement in a mounted position of said dispenser, such that a displacement of the rear wall of said dispenser at said load cell in a direction perpendicular to said rear wall is simplified.

17. The fill level monitoring system according to claim 10, wherein said consumer product is liquid soap provided in a container, or a stack of hand towels, or a roll of absorbent sheet material.

18. The fill level monitoring system according to claim 11, wherein said consumer product is liquid soap provided in a container having opening nozzle, said dispenser comprising a supporting member for supporting said nozzle, and said dispenser being configured to provide a distinct and in the direction perpendicular to said rear wall narrow contact surface between said nozzle and said supporting member.

19. The fill level monitoring system according to claim 1, wherein said load cell is secured to said load cell support member, and electronic circuits required to perform said fill level monitoring are provided within and/or on said load cell support member.

20. The fill level monitoring system according to claim 1, wherein said fill level monitoring system comprises an electronic fill level indicator.

21. The fill level monitoring system according to claim 19, wherein an electrical power source is provided within and/or on said load cell support member.
